(19) United States
(12) Patent Application Publication
(10) Pub. No.: US 2017/0083883 A1
(43) Pub. Date: Mar. 23, 2017

(54) Change Card

(71) Applicants: Richard A. Foston, Westerville, OH (US); Lisa E. Kelly, Westerville, OH (US)

(72) Inventors: Richard A. Foston, Westerville, OH (US); Lisa E. Kelly, Westerville, OH (US)

(21) Appl. No.: 14/859,223

(22) Filed: Sep. 18, 2015

(51) Int. Cl. G06Q 20/10; G06Q 20/34; G06Q 20/20

(52) U.S. Cl. CPC G06Q 20/105; G06Q 20/204; G06Q 20/3433

(57) ABSTRACT

The invention disclosure relates a method and system that converts routine cash sales transactions into a banking transaction at the point of sale. It provides cash sale purchasers, i.e. consumers, with the option of electronically depositing their change into a savings or other type of account with a financial institution at the point of sale. The account is linked to the consumer's magnetic stripe change card; the magnetic stripe is placed on the automated and transactional magnetic change card.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

(1) Field of the Invention

This invention disclosure relates to a method and system for converting coins, via a change card, at any point-of-sale or money transaction into electronic funds for saving or future purchases.

(2) Background of the Invention Significant increase in cost of living has encouraged people across the world to save money whenever possible and increase their cash amount. Generally, when people go shopping, the cash keeper usually does not pay much attention in giving back a small amount of change, or they end up exchanging or buying any other good in lieu of balance change to be given to the payer. This practice is getting prevalent across the world, and is extremely frustrating for the payers and consumers.

In order to overcome this problem, an acute need arises to have a system or method to keep the change to be returned to payer intact.

Many prior art exists that discloses different electronic systems that are efficient in keeping the money transaction records of user.

Such a prior art, U.S. Pat. No. 7395958 B2, discloses a method for conducting a monetary transaction where a customer is owed change at a merchant's establishment, wherein the customer to be credited with all or some of the change that is owed the customer, and recording the credited change on the data storage card. However, the method disclosed in this prior art is applicable only for the merchant and customer who are part of this scheme. There exists no centralized mechanism to carry forward this technique.

Another prior art, U.S. Pat. No. 7284696 B2, discloses a transaction card that allows for retail purchases involving fractional dollar amount to be completed without the use of coin currency. But this card is non- transferable.

Further prior art, US 20060207856 A1, discloses various methods and systems for exchanging various forms of value, including coins, currency, credit, debit, and/or bank account funds, for prepaid cash cards, credit cards, phone cards, gift cards, in-store gift certificates, e-certificates, and the like. However, the methods and systems disclosed herein are complex, and fail to provide a comprehensive solution to customers in order to accumulate the fractional change while conducting any purchase.

The current invention overcomes the shortcoming of the above-mentioned prior arts and provides a viable solution to the problem associated with financial transactions involving exchange of fractional change.

### SUMMARY OF THE INVENTION

The following summary is provided to facilitate an understanding of some of the innovative features unique to the disclosed embodiment, and is not intended to be a full description. A full appreciation of the various aspects of the embodiments disclosed herein can be gained by taking the entire specification, claims, drawings, and abstract as a whole.

The current invention disclosure discloses a method and system that converts routine cash sales transaction into a banking transaction at the point of sale. It provides cash sale purchasers, i.e. consumers, with the option of electronically depositing their change into a savings or other type of account with a financial institution at the point of sale. The account is linked to the consumer's magnetic stripe card that is placed on the automated and transactional magnetic change card.

The present invention provides a system and method for eliminating the need to use coinage in retail and other transactions as well as providing customers an opportunity to deposit accumulated coins at a Change Card kiosk to initiate a positive card balance at the time of Change Card purchase.

The present invention automatically converts a cash transaction into a transaction that provides an immediately tangible benefit to the consumer, the vendor and the linked financial institution.

The present invention provides a system and process for using change from cash sales transactions to fund the financial accounts at the point of sale.

It is further an objective of the current invention to provide the consumer with a simple and convenient way to begin or continue saving her hard-earned money.

Financial institutions have the immediate benefit of the instantaneous creation of a new banking relationship with the consumer, together with the immediate and regular infusion of significant volumes of cash into the financial institution from a previously untapped source—the point of sale.

Other objectives of the invention will become apparent to those skilled in the art once the invention has been shown and described. These objectives are not to be construed as limitations of the applicant's invention, but are merely aimed to suggest some of the many benefits that may be realized by the apparatus of the present application and with its many embodiments. In addition to the various objectives and advantages of the present invention, described with some degree of specificity above, it should be obvious that additional objectives and advantages of the present invention will become more readily apparent to those persons who are skilled in the relevant art from the following more detailed description of the invention.

### DETAILED DESCRIPTION OF THE INVENTION

The embodiments of the present disclosure, described below, are not intended to be exhaustive or to limit the disclosure to the precise forms disclosed in the following detailed description. Rather, the embodiments are chosen and described so that others skilled in the art may appreciate and understand the principles and practices of the present disclosure.

The following embodiments and the accompanying drawings, which are incorporated into and form part of this disclosure, illustrate embodiments of the invention, and, together with the description, serve to explain the principles of the invention.

The present invention disclosure discloses a method and system that converts routine cash sales transaction into a banking transaction at the point of sale. It provides cash sale purchasers, i.e. consumers, with the option of electronically depositing their change into a savings or other type of account with a financial institution at the point of sale. The account is linked to the consumer's magnetic stripe card that is placed on the automated and transactional magnetic change card.

The present invention requires the user to purchase the change card and update it with the personal details as well as the user's account detail. Once the card is updated with the user's details, it syncs with the financial institution electronically to the user's account that has the user's unique identifier (account number, email, username or phone number).

The process of the change card is simple in application; the user can purchase items, grocery etc. and make the payment in accordance to the final billing amount generated at point of sale. If the amount given by user leads to balance to be given to the user, this balance amount, in full or part, can be credited to user's account via use of change card which has an inbuilt magnetic strip to store the information about the transaction.

Basically, where the difference between an item purchase value and the amount tendered includes both fractional and whole dollar amounts, the entire difference may be either credited to or debited from the monetary value stored on the transaction card.

For example, if an individual purchases an item with a purchase value of $10.50, the individual may tender $20.00 along with the change card. In this case, the customers may receive $9.00 in cash and deposit $0.50 or choose to have the entire $9.50 in change, credited to the change card.

The monetary value stored in the change card memory is also available for secondary transactions, wherein the entire purchase price is debited from the monetary value of the change card. Alternatively, all or a portion of the monetary value can be deposited to a bank account via an ATM or over the counter transaction.

The change card can be repeatedly used at participating establishments, so that credited change accumulates thereon, with a running credit balance being maintained on the card.

The change card disclosed herein contains all the necessary details of the user, such as name, card number, and user's signature in order to ascertain the user's ownership with the card.

The change card is not only easy to use but also has a facility to enable user to transfer the amount accumulated in card via online transaction. The user can also transfer the card to another user after completing the necessary changes in the card.

Although specific embodiments have been illustrated and described herein, it will be appreciated by those of ordinary skill in the art that any arrangement that is calculated to achieve the same purpose may be substituted for the specific embodiment shown. This application is intended to cover any adaptations or variations of the present invention. Although specific terms are used in this specification, these terms are for convenience of description, and are not the limitation of the present invention in any combination.

Although the invention has been explained in relation to its preferred embodiment, it is to be understood that many other possible modifications and variations can be made without departing from the spirit and scope of the invention.

It is to be understood that the above description is intended to be illustrative, and not restrictive.

We claim:

1. The method for the conversion of cash sale transaction residuals into electronic format at the point of sale comprises of following steps:
i. providing a change card comprising a card body and a memory storage disposed on said card body;
ii. said memory storage comprising a magnetic swipe strip capable of being read by a card reader;
iii. said memory storage storing an identification for said change card and a monetary value for said change card; and
iv. said change card being associated with an account at a financial or commercial institution via user identification detail.

2. The system for conversion of cash sale transaction residual into electronic format comprises of:
i. a central database and point of sale or kiosk deposit at the point of card purchase;
i. said central database comprises a plurality of user accounts, each of said accounts having an associated change card identification;
ii. each of said plurality of user accounts reflecting a monetary value for said associated change card identification; and
iii. said plurality of user accounts are being updated periodically by receiving transmissions from at least one change card having at least one change card identification and monetary value recorded therein at point of sale.
